(19) United States
(12) Patent Application Publication
(10) Pub. No.: US 2026/0364649 A1
(43) Pub. Date: Nov. 19, 2026

(54) CLEANING DEVICE FOR PREVENTING GLUE BUILDUP ON A GLUE APPLICATION BOX

(71) Applicant: The Procter & Gamble Company, Cincinnati, OH (US)

(72) Inventors: Steven Alan LEE, JR., Jackson, MO (US); Logan Matthew LEITSCHUH, Cape Girardeau, MO (US); Johnny HENDRIX, Jackson, MO (US); Kent LANGSTON, Jackson, MO (US); Emily Renae BUIRGE; Victoria Grace STRAIN, Symmes Township, OH (US); Andre MELLIN, Amberley Village, OH (US); Gregory Scott EMMONS, Jackson, MO (US)

(21) Appl. No.: 19/206,135

(22) Filed: May 13, 2025

(51) Int. Cl. B08B 9/02; D21G 9/00

(52) U.S. Cl. CPC B08B 9/021; D21G 9/00; B08B 2209/02

(57) ABSTRACT

An apparatus may be provided to prevent buildup of glue on a glue application box. The glue application box may be included in a system comprising a moving surface configured to move in a direction from a leading edge to a trailing edge of the glue application box. The system may be configured to direct glue from within the glue application box onto the moving surface. The apparatus may include a cleaning device comprising a wiping mechanism configured to move along an outer surface of the trailing edge of the glue application box in a wiping direction to remove the buildup of glue on the outer surface of the trailing edge.

### FIELD

The present disclosure relates generally to glue application boxes and more specifically to a cleaning device for preventing glue buildup on a glue application box.

### BACKGROUND

A glue application box typically involves a glue spray device that sprays glue onto a moving surface that moves in a direction from the leading edge to the trailing edge of the glue application box. When the glue is sprayed in the direction of the moving surface, some of the sprayed glue which does not adhere to the moving surface may tend to follow the direction of the moving surface and adhere to an outer surface of the trailing edge of the glue application box. Thus, a common problem in the use of glue application boxes is the buildup of glue on the trailing edge of the glue application box, which can interfere with the operation of the glue application box.

In order to minimize the buildup of glue on the trailing edge of the glue application box, an air seal was developed at the trailing edge of the glue application box. The air seal causes an upward air flow or air knife to be formed between the trailing edge and the moving surface, in order to inhibit the movement of glue between the trailing edge and the moving surface. Thus, this air seal is intended to minimize the buildup of glue on the trailing edge of the glue application box.

However, the use of the air seal in conventional glue application boxes has drawbacks. For example, although the air seal is intended to inhibit the buildup of glue on the trailing edge of the glue application box, some glue inevitably adheres to the air seal and thus may block the upward air flow or air knife from the air seal. Consequently, this buildup of glue on the air seal routinely prevents proper operation of the air seal and thus inhibits the ability of the air seal to prevent glue buildup on the outer surface of the trailing edge of the glue application box.

The discussion of shortcomings and needs existing in the field prior to the present disclosure is in no way an admission that such shortcomings and needs were recognized by those skilled in the art prior to the present disclosure.

### SUMMARY

Various embodiments solve the above-mentioned problems and provide methods and devices useful for preventing glue buildup on an outer surface of a glue application box.

It was recognized that a cleaning device could be developed to be used with the glue application box. The cleaning device may feature a wiping mechanism that may be positioned in a slot of the air seal of the glue application box. The cleaning device may then be moved along the outer surface of the glue application, which may cause the wiping mechanism to move along the slot of the air seal and remove glue buildup within the slot of the air seal. This may advantageously remove any glue buildup within the air seal and consequently ensure that the air seal is continuously operable so to prevent glue buildup on the outer surface of the glue application box.

It was also recognized that although the cleaning device with the wiping mechanism may be configured to move along the outer surface of the glue application box, one or more conditions may inhibit the operation of the cleaning device. For example, if glue built up on the outer surface of the glue application box beyond a clearance between the outer surface of the glue application box and the cleaning device, the cleaning device may physically impact such glue buildup and thus may be inhibited from movement along the outer surface of the glue application box.

Thus, in order to address this potential issue, the cleaning device may be further configured to spray one or more streams of water on a respective one or more outer surfaces of the glue application box that may be most prone to glue buildup. It was recognized that by spraying these one or more streams of water at certain locations and/or at certain flow conditions (e.g. flow rate, pressure, etc.) glue buildup on these surfaces may be prevented or minimized. This may ensure that the cleaning device can move unobstructed along the outer surface of the glue application box. Furthermore, in the event that an extent of glue buildup exceeds the clearance between the outer surface of the trailing edge and the cleaning device, spraying these one or more streams on the built up glue may advantageously moisten the built up glue to the extent that the cleaning device can physically remove such glue buildup upon physical impact therewith.

In a first aspect of the disclosure, an apparatus may be provided to prevent buildup of glue on a glue application box. The glue application box may be included in a system comprising a moving surface configured to move in a direction from a leading edge to a trailing edge of the glue application box. The system may be configured to direct glue from within the glue application box onto the moving surface. The apparatus may include a cleaning device comprising a wiping mechanism configured to move along an outer surface of the trailing edge of the glue application box in a wiping direction to remove the buildup of glue on the outer surface of the trailing edge.

In a second aspect of the disclosure, an apparatus may be provided to prevent buildup of glue on a glue application box. The glue application box may be part of a papermaking system including a yankee that may be configured to move in a direction from a leading edge to a trailing edge of the glue application box. The system may be configured to direct glue from within the glue application box onto the yankee. A top of the trailing edge of the glue application box may comprise an air seal defining a slot in flow communication with one or more air channels configured to direct an air stream toward the moving surface. The apparatus may include a cleaning device comprising a wiping mechanism configured to be positioned within the slot. The wiping mechanism may be configured to move within the slot in a wiping direction to remove the buildup of glue within the slot.

These and other features, aspects, and advantages of various embodiments will become better understood with reference to the following description, figures, and claims.

### BRIEF DESCRIPTION OF THE DRAWINGS

Many aspects of this disclosure can be better understood with reference to the following figures, which illustrate examples according to various embodiments.

FIG. 1A is a schematic diagram of an example of a system for glue application, in accordance with an aspect of the disclosure;

FIG. 1B is a block diagram of an example of a system for glue application, in accordance with an aspect of the disclosure;

FIG. 2A is a top perspective view of an example of a cleaning device positioned on an outer surface of the glue application box, in accordance with an aspect of the disclosure;

FIG. 2B is a bottom perspective view of an example of the cleaning device of FIG. 2A, in accordance with an aspect of the disclosure;

FIG. 2C is a top view of an example of a scraper of the cleaning device moving within a slot of the air seal of FIG. 2A, in accordance with an aspect of the disclosure;

FIG. 2D is a cross-sectional view of an example of the scraper of the cleaning device moving within the slot of the air seal of FIG. 2C, taken along the line 2D-2D;

FIG. 2E is a cross-sectional view of an example of the scraper of the cleaning device moving within the slot of the air seal of FIG. 2C, taken along the line 2E-2E;

FIG. 2F is a cross-sectional view of an example of the scraper of the cleaning device moving within the slot of the air seal of FIG. 2C, taken along the line 2E-2E;

FIG. 2G is a cross-sectional view of an example of the scraper of the cleaning device moving within the slot of the air seal of FIG. 2C, taken along the line 2E-2E;

FIGS. 3A -3D are various views of an example of the cleaning device of FIG. 2A, in accordance with an aspect of the disclosure; and

FIG. 4 is a flowchart that illustrates an example of one or more steps of a method for preventing glue buildup on an outer surface of a glue application box.

It should be understood that the various embodiments are not limited to the examples illustrated in the figures.

### DETAILED DESCRIPTION

### Introduction and Definitions

This disclosure is written to describe the invention to a person having ordinary skill in the art, who will understand that this disclosure is not limited to the specific examples or embodiments described. The examples and embodiments are single instances of the invention which will make a much larger scope apparent to the person having ordinary skill in the art. Unless defined otherwise, all technical and scientific terms used herein have the same meaning as commonly understood by the person having ordinary skill in the art. It is also to be understood that the terminology used herein is for the purpose of describing examples and embodiments only, and is not intended to be limiting, since the scope of the present disclosure will be limited only by the appended claims.

All the features disclosed in this specification (including any accompanying claims, abstract, and drawings) may be replaced by alternative features serving the same, equivalent, or similar purpose, unless expressly stated otherwise. Thus, unless expressly stated otherwise, each feature disclosed is one example only of a generic series of equivalent or similar features. The examples and embodiments described herein are for illustrative purposes only and that various modifications or changes in light thereof will be suggested to the person having ordinary skill in the art and are to be included within the spirit and purview of this application. Many variations and modifications may be made to the embodiments of the disclosure without departing substantially from the spirit and principles of the disclosure. All such modifications and variations are intended to be included herein within the scope of this disclosure. For example, unless otherwise indicated, the present disclosure is not limited to particular materials, reagents, reaction materials, manufacturing processes, or the like, as such can vary. It is also to be understood that the terminology used herein is for purposes of describing particular embodiments only and is not intended to be limiting. It is also possible in the present disclosure that steps can be executed in different sequence where this is logically possible.

All numeric values are herein assumed to be modified by the term “about,” whether or not explicitly indicated. The term “about” generally refers to a range of numbers that one of skill in the art would consider equivalent to the recited value (for example, having the same function or result). In many instances, the term “about” may include numbers that are rounded to the nearest significant figure.

In everyday usage, indefinite articles (like “a” or “an”) precede countable nouns and noncountable nouns almost never take indefinite articles. It must be noted, therefore, that, as used in this specification and in the claims that follow, the singular forms “a,” “an,” and “the” include plural referents unless the context clearly dictates otherwise. Thus, for example, reference to “a support” includes a plurality of supports. Particularly when a single countable noun is listed as an element in a claim, this specification will generally use a phrase such as “a single.” For example, “a single support.”

Unless otherwise specified, all percentages indicating the amount of a component in a composition represent a percent by weight of the component based on the total weight of the composition. The term “mol percent” or “mole percent” generally refers to the percentage that the moles of a particular component are of the total moles that are in a mixture. The sum of the mole fractions for each component in a solution is equal to 1.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

In this specification and in the claims that follow, reference will be made to a number of terms that shall be defined to have the following meanings unless a contrary intention is apparent.

“Glue application box” refers to an enclosure that houses a glue spray device used to spray glue onto a moving surface that moves from a leading edge to a trailing edge of the glue application box.

“Substantially perpendicular” means an angle within a range from about 80 degrees to about 100 degrees.

“Papermaking machine” refers to a device that typically makes cellulosic products, such as tissue, by creating a pulp and water mixture that moves through a series of drying steps in a manufacturing process. The paper or tissue machine that may be used to create the product includes a series of drying stages that reduce the water content of the pulp and water mixture. A type of drying stage may include a drum that receives a web of cellulosic material. The drying drum may continue to remove water content from the web before the web is removed from the drum by a creeping blade.

“Machine direction” (MD) refers to the direction of material flow through a process. In addition, relative placement and movement of material can be described as flowing in the machine direction through a process from upstream in the process to downstream in the process.

“Cross direction” (CD) refers to a direction that is generally perpendicular to the machine direction.

### Apparatus to Prevent Glue Buildup on a Glue Application Box

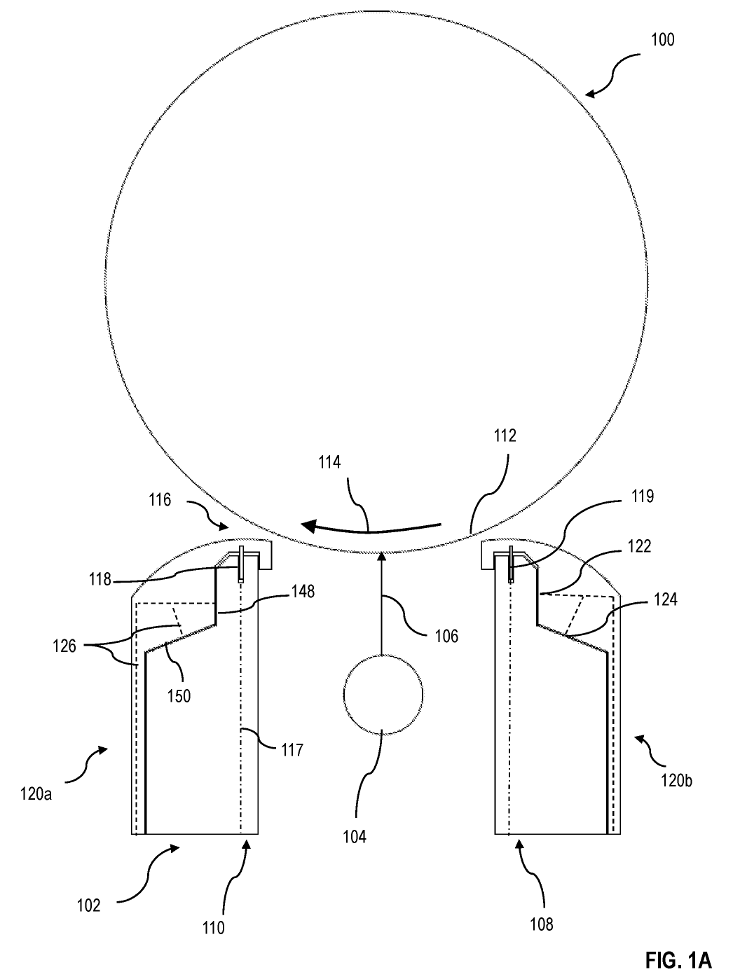

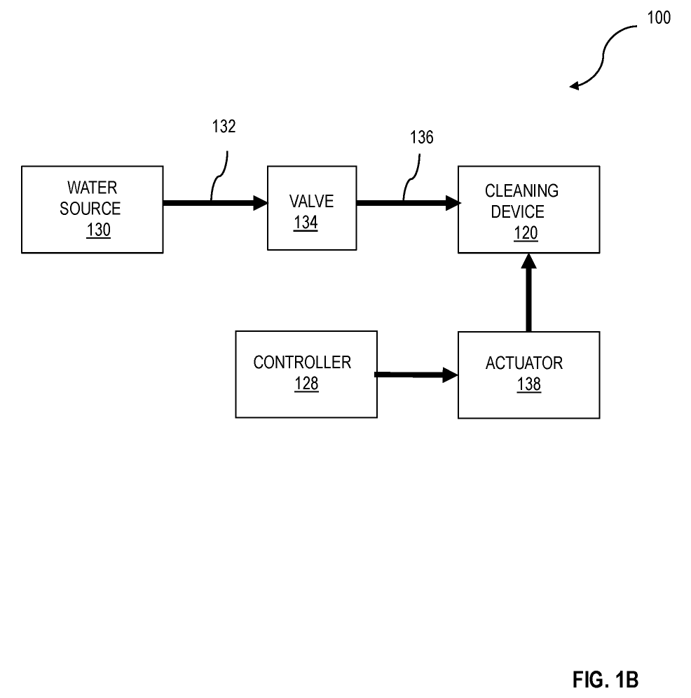

A system used for applying glue may now be discussed. FIG. 1A is a schematic diagram of an example of a system 100 for glue application, in accordance with an aspect of the disclosure. The system 100 may include a moving surface 112 configured to move in a direction 114 from a leading edge 108 to a trailing edge 110 of a glue application box 102. As shown in FIG. 1A, the glue application box 102 may enclose a glue spray device 104 configured to spray glue 106 in a direction to the moving surface 112. In one example, the direction 114 may be the machine direction (MD) at the location where glue 106 is sprayed onto the moving surface 112.

Different types of systems that may be used for applying glue are now discussed. As appreciated by one skilled in the art, the system 100 may form one aspect of a papermaking machine, where upon spraying the glue 106 on the moving surface 112 (e.g. yankee), one or more layers of paper material are then adhered to the moving surface 112 in a subsequent stage of the papermaking process. However, the glue application box 102 of the system 100 is not limited to papermaking machines and may also include, but is not limited to, one or more of converting paper products such as embosser laminator glue application, core making with glue adhesive, or tailsealing the last sheet of the converted log.

An air seal of the system will now be discussed. As depicted in FIG. 1A, the system 100 may also feature an air seal 116 adjacent a top of the glue application box 102, such as adjacent a top of the trailing edge 110 and/or a top of the leading edge 108 of the glue application box 102. The air seal 116 may be used to establish an air barrier (e.g. air knife) in the gap between the top of the trailing edge 110 and/or the top of the leading edge 108 and the moving surface 112, so to prevent the passage of glue through the gap that did not adhere to the moving surface 112. In one example, the air seal 116 may feature one or more air channels 117 within the trailing edge 110 and/or leading edge 108 of the glue application box 102 that may be configured to direct air in a direction toward the gap between the trailing edge 110 and/or leading edge 108 and the moving surface 112. In one example, the one or more air channels 117 may be in flow communication with a pressurized air source (not shown). As further shown in FIG. 1A, the air seal 116 may also include a slot 119 defined in the top of the trailing edge 110 and/or leading edge 108, where the slot 119 is in flow communication with the one or more air channels 117. Thus, upon activation of the air seal 116, pressurized air may flow upward through the one or more air channels 117 and in an upward direction out of the slot 119 toward the moving surface 112, thereby forming the air barrier or air knife in the gap between the trailing edge 110 and/or the leading edge 108 and the moving surface 112.

One or more potential issues that may arise with the operation of the air seal are now discussed. It was recognized that although the air seal 116 may advantageously provide the air barrier to prevent the unwanted passage of glue through the gap between the trailing edge 110 and/or leading edge 108 and the moving surface 112, one or more conditions may occur that may inhibit proper operation of the air seal 116. For example, it was recognized that if glue 106 that did not adhere to the moving surface 112 enters the slot 119 and builds up therein, this may inhibit the formation of the air barrier.

An apparatus is now disclosed herein, that may be used to prevent and/or address the potential issues that may arise with the operation of the air seal. In order to address this undesired condition that may affect the proper operation of the air seal 116, an apparatus may be provided, to prevent a buildup of glue on the glue application box 102. As shown in FIG. 1A, the apparatus may include a cleaning device 120 that may be configured to move along an outer surface of the glue application box 102. In one example, the cleaning device 120 may be configured to move in a cross direction (CD) that is orthogonal to the MD of the moving surface 112 at the location where the glue 106 is sprayed thereon. As shown in FIG. 1A, the cleaning device 120 may include a wiping mechanism 118 configured to be positioned within the slot 119 and configured to move in a wiping direction (e.g. CD) along the slot 119, based on the movement of the cleaning device 120 along the outer surface of the glue application box 102. The wiping mechanism 118 may remove glue buildup within the slot 119 and thus may prevent glue buildup within the slot 119 from interfering with proper operation of the air seal 116.

In one example, the cleaning device 120 may feature a nonstick coating. In one example, the nonstick coating of the cleaning device 120 may be made of Teflon^{®} (polytetrafluoroethylene (PTFE)). In this example, PTFE is a synthetic fluoropolymer. In another example, the nonstick coating of the cleaning device 120 may be made of a ceramic material. In yet another example, the nonstick coating of the cleaning device 120 may be made from silicone material. In yet another example, the nonstick coating of the cleaning device 120 may be made from Anodized Aluminum material (with nonstick finish). In yet another example, the nonstick coating of the cleaning device 120 may be made from Enameled Cast Iron material. In yet another example, the nonstick coating of the cleaning device 120 may be made from PFOA-Free PTFE Variants. In yet another example, the nonstick coating of the cleaning device 120 may be a Titanium-Infused Coating. In yet another example, the nonstick coating of the cleaning device 120 may be made from Fluoropolymer Alternatives (e.g., Xylan). One or more potential issues that may arise during operation of the cleaning device will now be discussed. It was also recognized that although the cleaning device 120 may advantageously ensure that glue buildup within the slot 119 does not interfere with proper operation of the air seal 116, one or more conditions may occur that may inhibit movement of the cleaning device 120 along the outer surface of the glue application box 102. For example, as discussed in more detail herein, if glue passes through the gap between the glue application box 102 and the moving surface 112 and adheres to the outer surface of the glue application box 102, this glue buildup may physically inhibit movement of the cleaning device 120 along the outer surface of the glue application box 102. For example, such physical inhibition of the cleaning device 120 may occur if the glue buildup on the outer surface of the glue application box 102 exceeds a clearance between the outer surface of the glue application box 102 and the cleaning device 120.

Further aspects of the apparatus will now be discussed that may be used to prevent or avoid the potential issues that may arise during operation of the cleaning device. Thus, the apparatus may be further configured to ensure that the movement of the cleaning device 120 along the outer surface of the glue application box 102 is not inhibited by excessive glue buildup on the outer surface of the glue application box 102. For example, as shown in FIG. 1A, the apparatus may feature one or more interior channels 126 that are configured to pass fluid (e.g. water). These interior channels 126 may be in flow communication with a fluid source (e.g. water source). As shown in FIG. 1A, the one or more interior channels 126 may direct fluid against one or more outer surfaces of the glue application box 102. In one example, as shown in FIG. 1A, the one or more interior channels 126 may direct fluid out one or more openings 122, 124 defined by the cleaning device 120 so to direct fluid at an angle that is substantially perpendicular to the respective one or more surfaces. As shown in FIG. 1A, in one example the cleaning device 120 may define a first opening 122 in fluid communication with the interior channels 126 that is configured to direct fluid against a first surface 148 of the trailing edge 110 at an angle that is substantially perpendicular to the first surface 148. Similarly, as shown in FIG. 1A, in one example the cleaning device 120 may define a second opening 124 in fluid communication with the interior channels 126 that is configured to direct fluid against a second surface 150 of the trailing edge 110 at an angle that is substantially perpendicular to the second surface 150. Although FIG. 1A depicts one example where the cleaning device 120 defines two openings 122, 124 to direct fluid against two respective surfaces 148, 150 of the glue application box 102, in other aspects of the disclosure the cleaning device 120 may define less or more than two openings to direct fluid against less or more than two respective surfaces of the glue application box 102.

In the example of FIG. 1A, a first cleaning device 120a may be configured to move along an outer surface of the trailing edge 110 of the glue application box 102 and a second cleaning device 120b may be configured to move along an outer surface of the leading edge 108 of the glue application box 102. In this example, the cleaning devices 120a, 120b share similar features but may be asymmetrical with respect to each other. Thus, for purposes of the discussion herein, one or more features of one of the cleaning device 120 herein may be shared by each of the cleaning devices 120a, 120b in an asymmetrical respect, as depicted in FIG. 1A.

A block diagram of the system will now be discussed. FIG. 1B is a block diagram of an example of the system 100 for glue application, in accordance with an aspect of the disclosure. This block diagram may depict components of the system that may be employed to direct fluid (e.g. water) to the one or more interior channels 126 of the cleaning device 120 so to direct fluid onto the surfaces 148, 150 of the glue application box 102. As shown in FIG. 1B, the system 100 may include a hard pipe 132 that defines a water line configured to supply water from a water source 130 to a valve 134. In one example, the valve 134 may be a manual valve that is manually opened or closed. In another example, the valve 134 may be an automatic valve that is communicatively coupled with a controller and opens or closes based on a signal received from the controller. As further depicted in FIG. 1B, in one example the apparatus may include a flexible line 136 in flow communication with the hard pipe 132 (through the valve 134) and in flow communication with the one or more openings 122, 124 of the cleaning device 120. Thus, upon actuation of the valve 134, water may be directed from the water source 130, through the valve 134, through the interior channels 126 of the cleaning device 120 and directed out the openings 122, 124 of the cleaning device 120 onto the respective surfaces 148, 150 of the glue application box 102.

A motor or actuator may be employed in the apparatus to move the cleaning device 120 along the outer surface of the glue application box 102 including the first cleaning device 120a along the trailing edge 110 and the second cleaning device 120b along the leading edge 108. As shown in FIG. 1B, a controller 128 may be provided with the apparatus that is communicatively coupled with a motor or actuator 138. In one example, the motor or actuator 138 may be a pneumatic actuator. However, in other examples, the motor or actuator 108 may be a rodless cylinder or a hydraulic cylinder. Upon receiving a first signal from the controller 128, the motor or actuator 138 may cause the cleaning device 120 to move along the outer surface of the glue application box 102. In still other examples, the cleaning device 120 may be driven by one or more of air cylinder, a hydraulic cylinder, or a motor. In still other examples, the cleaning device 120 may be moved in a constant motion or variable movement and positioning.

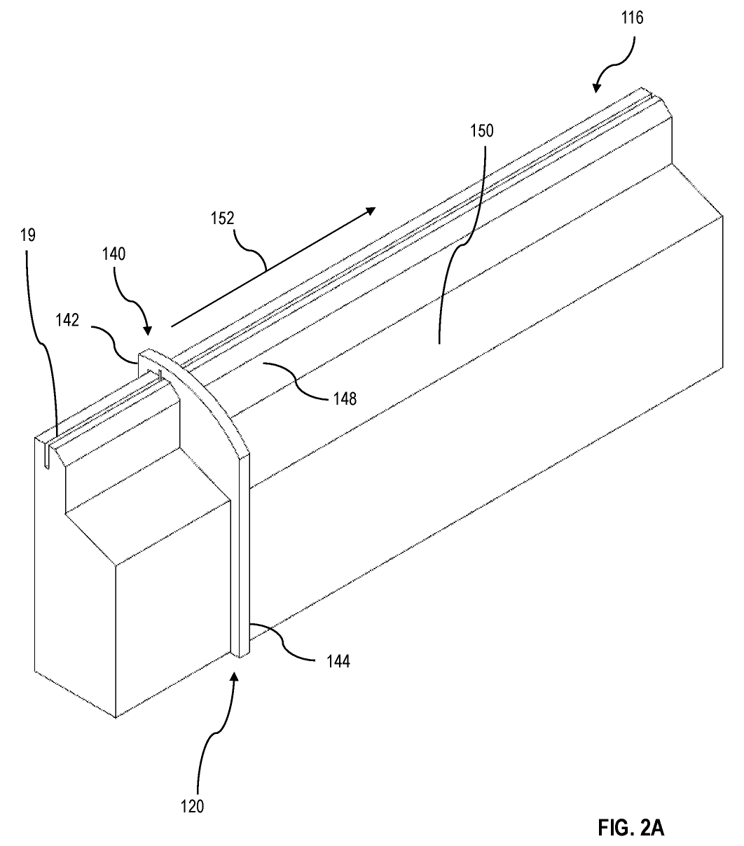

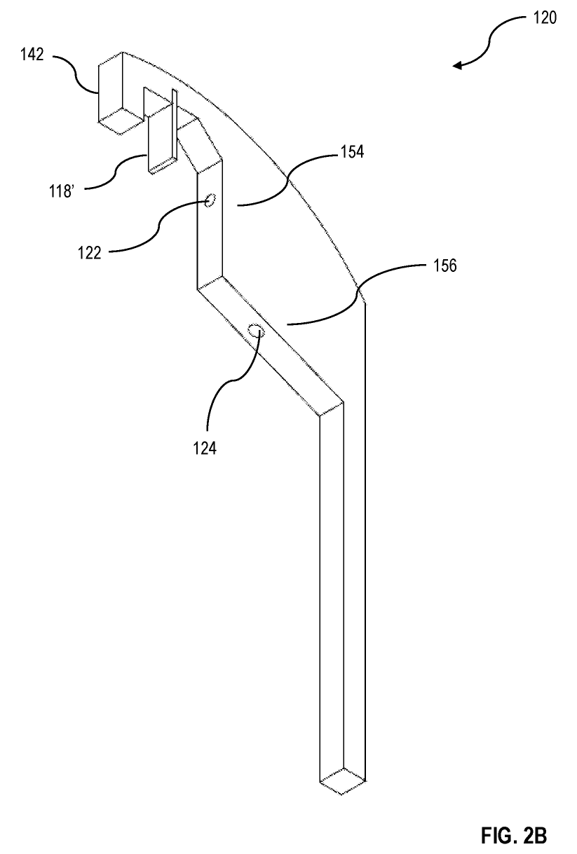

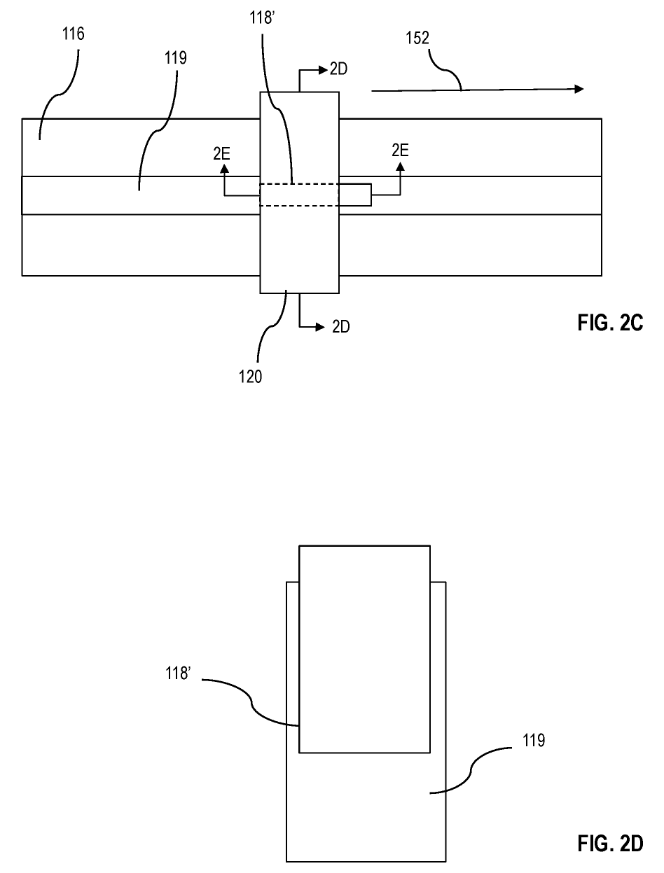

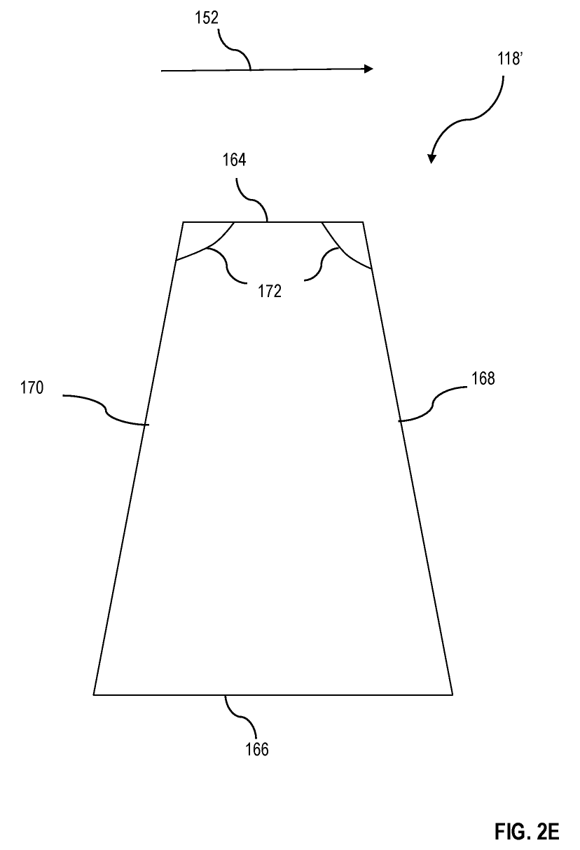

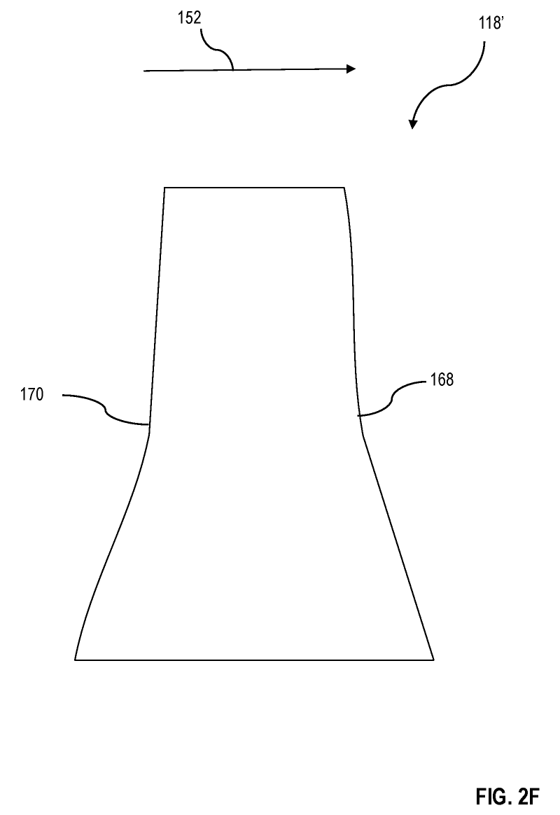

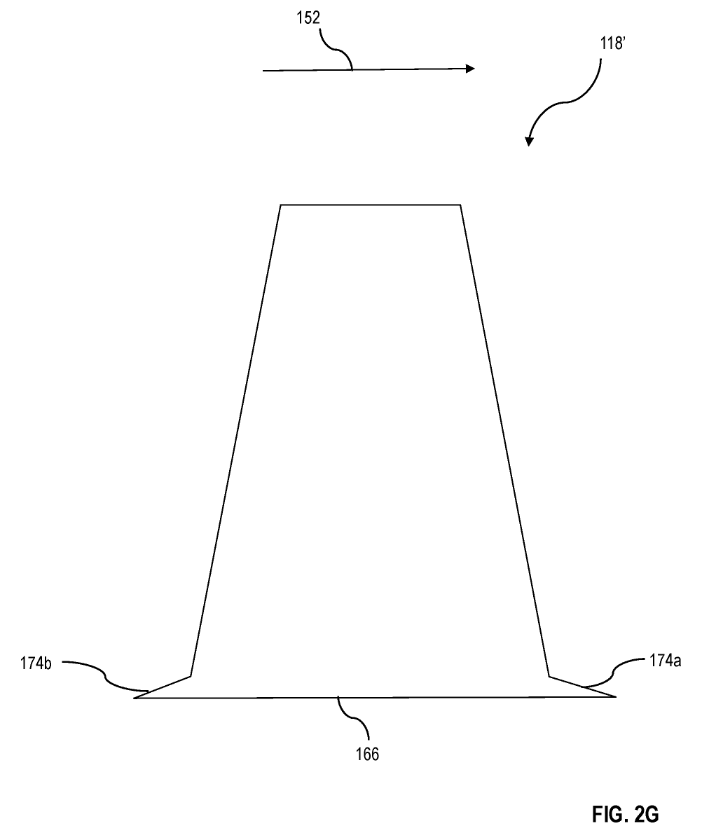

FIG. 2A is a top perspective view of an example of the cleaning device 120 positioned on an outer surface of the glue application box 102, in accordance with an aspect of the disclosure. As depicted in FIG. 2A, the cleaning device 120 may include a hook portion 142 configured to engage the top 140 of the trailing edge 110.

The wiping mechanism 118 (not shown in FIG. 2A) may be positioned within the slot 119 of the air seal 116. As the cleaning device 120 moves in a direction 152 along the outer surface of the trailing edge 110, the wiping mechanism 118 may move within the slot 119 along the direction 152 and thus may remove glue buildup within the slot 119. In one example the direction 152 may be referred to as a wiping direction since its corresponds to the direction that the wiping mechanism 118 may move within the slot 119 in order to remove glue buildup within the slot 119. In another example, the direction 152 may correspond with the CD since it is substantially perpendicular to the MD at which the moving surface 112 moves between the leading and trailing edges 108, 110 of the glue application box 102 (FIG. 1A).

A speed of the cleaning device 120 along the outer surface of the glue application device 102 is now discussed. In one example, the cleaning device 120 may be moved along the outer surface of the trailing edge 110 at a speed that is between about 0.9 inches per second and 1.0 inches per second and/or between about 0.8 inches per second and 1.1 inches per second It was recognized that moving the cleaning device 120 at a speed in this range of values may be advantageous, as it may ensure that the device substantially cleans the air seal slot at a rate that prevents build up that is too hard for it to break through and at a speed that pushes the build up instead of knocking it free to go into the process. If the device is moved too quickly, it may present the risk to the process by removing the build up aggressively and freeing it up to get caught in the in-running nip. It also may utilize the actuator more frequently without seeing the benefit of improving the process if it went more quickly.

The outer surfaces of the glue application box 102 against which the fluid may be directed from the openings of the cleaning device are now discussed. FIG. 2A depicts that the trailing edge 110 may feature a first surface 148 that is adjacent to the top of the trailing edge 110 and also adjacent to and below the air seal 116 (and slot 119). In one example, the fluid directed from the first opening 122 (FIG. 1A) of the cleaning device 120 may be directed on the first surface 148 of the trailing edge 110 at an angle that is substantially perpendicular to the first surface 148. Similarly, in another example, the fluid directed from the second opening 124 (FIG. 1A) of the cleaning device 120 may be directed on the second surface 150 of the trailing edge 110 at an angle that is substantially perpendicular to the second surface 150. In one example, the second surface 150 may feature a cladding portion of the trailing edge 110. As further shown in FIG. 2A, the second surface 150 may be angled relative to the first surface 148.

The basis for directing fluid on the first and second surfaces 148, 150 of the glue application box 102 will now be discussed. In one example, the first and second surfaces 148, 150 were selected since they may be the surfaces of the trailing edge 110 where glue buildup is likely to occur. This may be due to the proximity of the first and second surfaces 148, 150 to the top of the glue application box 102 over which glue passes that does not adhere to the moving surface 112. It was recognized that in the event that glue buildup on an outer surface of the trailing edge 110 accumulated beyond a clearance between the cleaning device 120 and the glue application box 102, such glue buildup may physically impede the ability of the cleaning device 120 to move along the outer surface of the trailing edge 110 and thus impede the ability of the wiping mechanism 118 to move within the slot 119 and clear glue buildup therein. Thus, in one example, the first and second surfaces 148, 150 were selected due to their proximity to the top of the glue application box 102, over which glue 106 that did not adhere to the moving surface 112 may pass and fall onto the surfaces 148, 150 of the trailing edge 110.

In another example, the first and second surfaces 148, 150 of the glue application box 102 may be selected in order to minimize a torque being imparted on the cleaning device 120 due to glue buildup. For example, the motor or actuator 138 may be coupled to a bottom 144 of the cleaning device 120 such that the motor or actuator 138 imparts a force to the cleaning device 120 adjacent to the bottom 144 in order to move the cleaning device 120 along the outer surface of the glue application box 102. Since the first and second surfaces 148, 150 are relatively distal from the bottom 144 where the motor or actuator 138 imparts a force on the cleaning device 120, glue buildup in the first or second surfaces 148, 150 may impart a relatively large torque on the cleaning device 120 should the glue buildup physically impact the cleaning device 120. Thus, in this example, the first and second surfaces 148, 150 may be selected to direct fluid, in order to prevent a glue buildup thereon and thus to prevent a relatively large torque being imparted on the cleaning device 120. In another example, the first and second surfaces 148, 150 may be selected to direct fluid, in order to moisten an existing glue buildup thereon to the extent that the cleaning device 120 may be capable of breaking through the glue buildup without affecting the movement of the cleaning device 120. In another example, instead of or in addition to directing fluid on the first and second surfaces 148, 150, the apparatus may provide a second motor or actuator that is coupled with the top 140 of the cleaning device 120. In this example, such second motor or actuator may further reduce the likelihood of a relatively large torque being imparted on the cleaning device 120 due to glue buildup, since there may no longer be a relatively large distance between the imposition of force on the cleaning device 120 and the location of impact of glue buildup on the cleaning device 120.

Different portions of the cleaning device will now be discussed. FIG. 2B is a bottom perspective view of an example of the cleaning device 120 of FIG. 2A, in accordance with an aspect of the disclosure. As shown in FIG. 2B, the cleaning device 120 may define a first portion 154 defining the first opening 122, where the apparatus is configured to direct a first stream of fluid (e.g. water) from the first opening 122 in a direction that is substantially perpendicular to the first surface 148 of the trailing edge 110. In this example, as the cleaning device 120 is moved along the outer surface of the trailing edge 110, the first portion 154 may move along the first surface 148 of the trailing edge 110. Additionally, as shown in FIG. 2B, the cleaning device 120 may define a second portion 156 defining the second opening 124 of the cleaning device 120. The apparatus may be configured to direct a second stream of fluid (e.g. water) from the second opening 124 in a direction that is substantially perpendicular to the second surface 150 of the trailing edge 110. In this example, as the cleaning device 120 is moved along the outer surface of the trailing edge 110, the second portion 156 may move along the second surface 150 of the trailing edge 110. In an example, the first portion 154 of the cleaning device 120 may be located between the hook portion 142 and the second portion 156 of the cleaning device 120.

The position and/or orientation of the wiping mechanism 118 within the slot 119 will now be discussed. In one example, the cleaning device 120 may be configured such that the wiping mechanism 118 is positioned within the slot 119 such that the wiping mechanism 118 is oriented in a direction that is perpendicular with the wiping direction 152 (FIG. 2A). Thus, in this example, the wiping mechanism 118 may be oriented such that no portion of the wiping mechanism 118 is oriented along the wiping direction 152. However, the cleaning device 120 is not limited to this arrangement of the wiping mechanism 118. In one example, the wiping mechanism may be a scraper 118’ that is a relatively thin sheet of metal. As depicted in FIG. 2C, in some examples, the scraper 118’ may be oriented such that it is at least partially oriented along the wiping direction 152. It was recognized that this partial orientation of the scraper 118’ along the wiping direction 152 may enhance the removal of glue buildup within the slot 119. However, the orientation of the wiping mechanism 118 within the slot 119 relative to the wiping direction 152 is not limited to these specific examples.

Another orientation of the wiping mechanism 118 within the slot 119 is now discussed. FIG. 2D is a cross-sectional view of an example of the scraper 118’ of the cleaning device 120 moving within the slot 119 of the air seal 116 of FIG. 2C, taken along the line 2D-2D. As shown in FIG. 2D, in one example the scraper 118’ may take a rectangular profile when viewed along the direction 152 (in a plane defined by line 2D-2D). FIG. 2E is a cross-sectional view of an example of the scraper 118’ of the cleaning device 120 moving within the slot 119 of the air seal 116 of FIG. 2C, taken along the line 2E-2E. As shown in FIG. 2E, a width of a top 164 of the scraper 118’ along the direction 152 (as measured in the 2E-2E plane) may be smaller than a width of a bottom 166 of the scraper 118’ . In this example, the scraper 118’ may take the shape of a trapezoid in the 2E-2E plane. As further shown in FIG. 2E, the scraper 118’ may feature a first side 168 and a second side 170, where the first and second side 168, 170 each may form an angle 172 with the top 174 of the scraper. In one example, the first side 168 of the scraper 118’ may be used to scrape glue buildup out of the slot 119, when the scraper 118’ moves in the direction 152 (e.g. CD) within the slot 119. In another example, the second side 170 of the scraper 118’ may be used to scrape glue buildup out of the slot 119, when the scraper 118’ moves in a direction opposite to the direction 152 within the slot 119.

In one example, the angle 172 may be in a range that is greater than about 90 degrees and less than about 180 degrees and/or in a range that is greater than about 100 degrees and less than about 160 degrees; and/or in a range that is greater than about 110 degrees and less than about 140 degrees. In one example, the angle 172 is selected to be a value greater than 90 degrees such that the first side 168 of the scraper 118’ (when moving in the direction 152) can effectively scrape glue buildup out of the slot 116 and move said scraped glue buildup in an upward direction toward the scraper top 164 and out of the slot 116. Similarly, in another example, the angle 172 is selected to be a value greater than 90 degrees such that the second side 168 of the scraper 118’ (when moving in the direction opposite to the direction 152) can effectively scrape glue buildup out of the slot 116 and move said scraped glue buildup in an upward direction toward the scraper top 164 and out of the slot 116.

Although FIG. 2E depicts that the scraper 118’ may take a trapezoid shape, the scraper 118’ is not limited to the shape depicted in FIG. 2E. In another example, the scraper 118’ may take a similar shape as the trapezoid of FIG. 2E, with the exception that the first side 168 and second side 170 are curved with a radius of curvature. Thus, unlike the first and second side 168, 170 of the trapezoid shaped scraper 118’ of FIG. 2E, which are not curved nor have a radius of curvature, the first and second sides 168, 170 of the scraper 118’ may be curved with a radius of curvature. In one example, the first and second sides 168, 170 of the scraper 118’ are curved with a concave radius of curvature. This curved shape of the first and second sides 168, 170 of the scraper 118’ in FIG. 2F may enhance the ability of the scraper 118’ to remove glue buildup within the slot 119, since the curvature in the first and second sides 168, 170 may enhance the degree to which the scraper 118’ can scrape the glue buildup out of the slot 119 and in an upward direction towards the top 164 of the scraper 118’ and out of the slot 119.

In still another example, FIG. 2G is presented which depicts another example of the scraper 118’. In the example of FIG. 2G, the scraper 118’ may take a similar shape as the trapezoid shape of FIG. 2E or the curved shape of FIG. 2F, but may further feature a hook 174a adjacent a bottom of the first side 168 adjacent the scraper bottom 166 and a hook 174b adjacent a bottom of the second side 170 adjacent the scraper bottom 168. In this example, the hooks 174a, 174b adjacent the respective bottoms of the first and second sides 168, 170 of the scraper 118’ may enhance the ability of the scraper 118’ to scrape glue buildup out of the slot 119 and in an upward direction towards the top 164 of the scraper 118’ and out of the slot 119.

An image that depicts an example of the first and second surfaces along the outer surface of the glue application box where fluid may be directed is shown. In the example of FIG. 2A, the first and second surfaces 148, 150 along the trailing edge 110 where the water is directed from the respective openings 122, 124 of the cleaning device 120 is shown. As previously disclosed, these first and second surfaces 148, 150 may advantageously correspond with those outer surfaces of the trailing edge 110 where glue buildup is most likely to occur and thus where removal and/or moistening of glue buildup therein may ensure proper continued operation of the cleaning device 120.

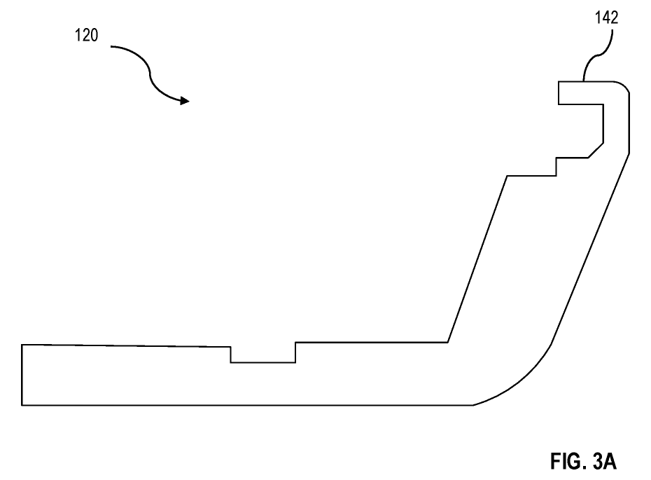

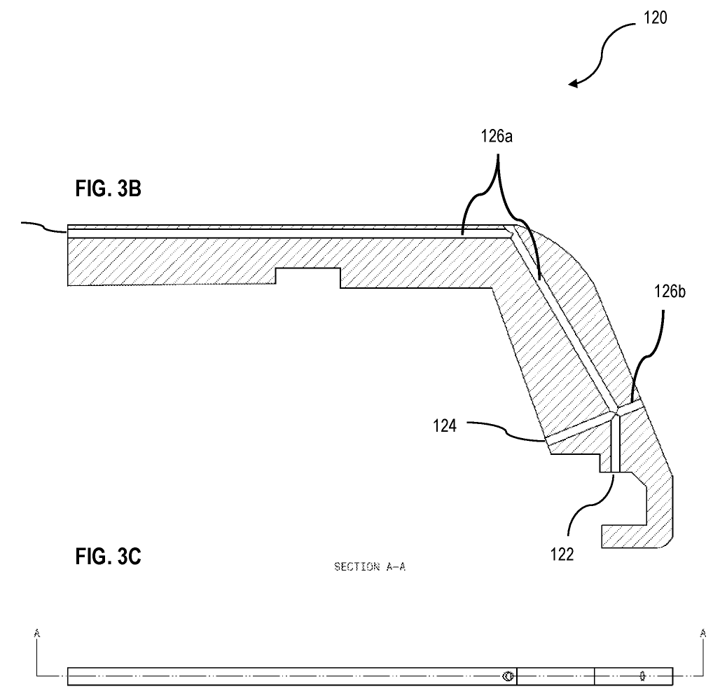

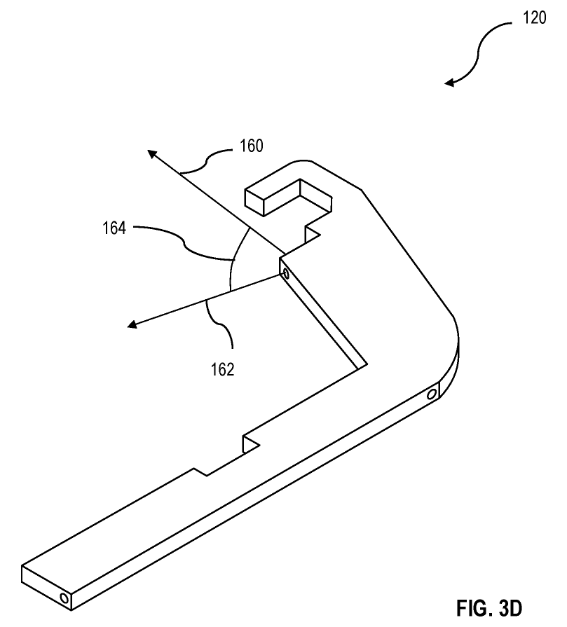

FIGS. 3A-3D are various views of an example of the cleaning device 120 of FIG. 2A, in accordance with an aspect of the disclosure. As shown in FIG. 3B, the cleaning device 120 may define an inlet 123 and one or more interior channels 126 between the inlet 123 and the first and second openings 122, 124 such that the inlet 123 is in flow communication with the first and second openings 122, 124. In one example, an inner diameter of the inlet 123 or the one or more interior channels 126 may be greater than an inner diameter of the first and second openings 122, 124.

A passage of water through the cleaning device 120 is now discussed. In one example, the flexible line 136 (FIG. 1B) may be connected with the inlet 123 of the cleaning device 120. Thus, in this example, water may flow from the water source 130 , through the inlet 134 (when open) and through the inlet 123 of the cleaning device 120. The water may then flow through the one or more interior channels 126 of the cleaning device 120 before being directed out of the first and second openings 122, 124 on the respective first and second surfaces 148, 150 of the trailing edge 110.

Various parameters of the water flow out of the first and second openings 122, 124 is now discussed. In one example, the streams of water directed out of the first and second openings 122, 124 may be directed at a flowrate between about 1 gallons per minute to about 2 gallons per minute and/or further may be directed at a pressure between about 10 pounds per square inch and 20 pounds per square inch. In one example, one or more dimensional parameters of the cleaning device 120 may be adjusted, so that the streams of water from the first and second openings 122, 124 may have one or more of these desired properties. In one example, the inner diameter of the inlet 123, interior channels 126 and/or the openings 122, 124 may be adjusted relative to each other, such that the streams of water from the openings 122, 124 have one or more of these desired flow properties. It was recognized that by selecting the first and second surfaces 148, 150 to spray water which may be the most likely to feature glue buildup, the value of the pressure of the water being directed on the outer surface of the trailing edge 110 may be substantially less than if a different surface of the trailing edge 110 was sprayed with the water streams. Thus, in this example, the apparatus may conserve water while preventing glue buildup on the outer surface of the glue application box 102.

In another example, the cleaning device 120 may feature fixed shower headers that may run a higher volume for water. In still other examples, the cleaning device 120 may run larger piping, smaller piping, different water source, or a higher pressure. In still other examples, different cleaning resources (e.g. other than water) may be utilized, such as steam or air.

An angular relationship between the openings of the cleaning device are now discussed. As shown in FIGS. 3B and 3D, the first portion 154 of the cleaning device 120 may define the first opening 122 such that an axis of the first opening is aligned in a first direction 160 and the second portion 156 may define the second opening 124 such that an axis of the second opening is aligned in a second direction 162. As further shown in FIG. 3D, an angle 164 may be provided between the first and second directions 160, 162. In an example the angle 164 may have a value that is greater than about 0 degrees and less than about 90 degrees and/or is greater than about 20 degrees and less than about 70 degrees.

### Method to Prevent Glue Buildup on a Glue Application Box

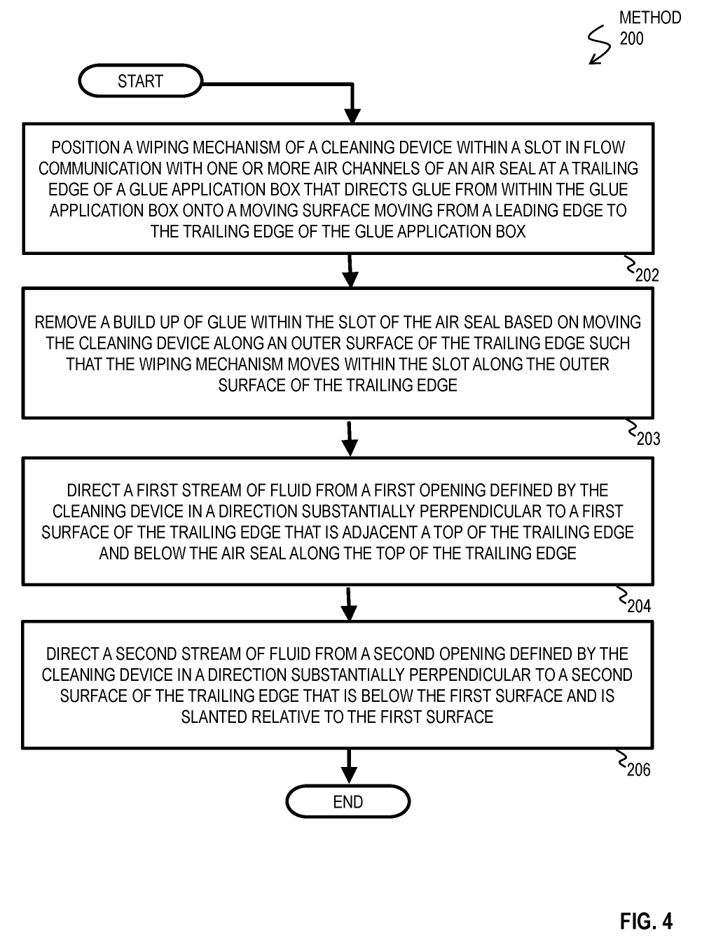

FIG. 4 is a flowchart that illustrates an example of one or more steps of a method 200 for preventing glue buildup on the outer surface of the glue application box 102. Although the flow diagram of FIG. 4 may be depicted as integral steps in a particular order for purposes of illustration, in other embodiments one or more steps, or portions thereof, are performed in a different order, or overlapping in time, in series or in parallel, or are deleted, or one or more other steps may be added, or the method may be changed in some combination of ways. Although some of the steps of the method 200 are discussed with respect to the trailing edge 110 of the glue application box 102, it should be noted that the same steps may be similarly performed with respect to the leading edge 108 of the glue application box 102.

In step 202, the apparatus may be positioned in order to remove glue buildup from the glue application box 102. In one example, in step 202 the wiping mechanism 118 of the cleaning device 120 may be positioned within the slot 119. In another example, in step 202 the cleaning device 120 is slidably connected to the outer surface of the glue application box 102 such that the cleaning device 120 can slidably move in the direction 152 along the outer surface of the glue application box 102 (e.g. trailing edge 110 and/or leading edge 108). In step 202, the motor or actuator 138 may be operatively connected to the cleaning device 120 (e.g. bottom 144) so that the motor or actuator 138 is configured to move the cleaning device 120 along the outer surface of the glue application box 102 (e.g. trailing edge 110 or leading edge 108). Components such as slidable blocks, slidable rails and/or slidable bars may be provided, to facilitate the movement of the cleaning device 120 along the outer surface of the trailing edge 110 in the direction 152.

In one example, in step 202 the position or orientation of the wiping mechanism 118 may be adjusted, relative to the slot 119 in order to enhance or maximize the extent to which the wiping mechanism 118 may remove glue buildup from within the slot 119. In another example, in step 202 the shape or configuration of the wiping mechanism 118 may be selected, to enhance the extent to which the wiping mechanism 118 may remove glue buildup from within the slot 119. In this example, in step 202 the shape of the scraper 118’ may be selected from one of FIGS. 2E-2G based on an enhanced ability to remove glue buildup from within the slot 119.

In step 203, the glue buildup within the slot 119 of the glue application box 102 may be removed based on step 202 of moving the wiping mechanism 118 within the slot 119 in the wiping direction 152.

In steps 204 and 206, one or more steps are performed in order to enhance the operation of the cleaning device 120. In one example, these steps 204 and 206 may be performed to prevent a buildup of glue on the outer surface of the glue application box 102 to an extent that exceeds a clearance between the cleaning device 120 and the outer surface of the glue application box 102. This reliably ensures that glue buildup does not physically inhibit the movement of the cleaning device 120 in the direction 152 along the outer surface of the glue application box 102.

In still another example, these steps 204 and 206 may be performed to moisten an existing glue buildup on the outer surface of the glue application box 102 such that the cleaning device 120 can easily break through such moistened glue buildup when the cleaning device 120 physically impacts said moistened buildup. Thus, these steps 204 and 206 may permit the cleaning device 120 to physically remove an excessive amount of glue buildup after such buildup is moistened during steps 204 and 206.

In step 204, a first stream of fluid (e.g. water) may be directed from the first opening 122 defined by the cleaning device 120 in a direction that is substantially perpendicular to the first surface 148 of the trailing edge 110. In this example, the first surface 122 may be adjacent to a top of the trailing edge 110.

In step 206, a second stream of fluid (e.g. water) may be directed from the second opening 124 defined by the cleaning device 120 in a direction that is substantially perpendicular to the second surface 150 of the trailing edge 110. In this example, the second surface 150 may be adjacent to the first surface 148 (e.g. below the first surface 148) and angled relative to the first surface 148.

In an example, in step 204 the valve 134 may be opened such that water may flow from the water source 130 through the pipe 132 and flexible line 136 and into the inlet 123 of the cleaning device 120. The water may then flow through the interior channels 126 and may be directed out each of the openings 122, 124 of the cleaning device 120.

In one example, steps 202 through 206 may be continuously performed during operation of the system 100 (e.g. during the spray operation of glue 106 onto the moving surface 112). In this example, upon reaching one end of the glue application box 102, the cleaning device 120 may be configured to move in an opposite direction (e.g. a direction opposite to the direction 152) until an opposite end of the glue application box 102 is reached. These steps may be repeated until the glue spray operation of the system 100 is completed.

In an example, the problem to be solved by the apparatus herein may include a glue/fiber buildup that may become hardened on an outer surface of a glue application box 102 and may require manual intervention to clean when the system 100 (e.g. papermaking machine) is not in production. Thus, this problem may lead to planned and unplanned downtime of the system 100 that may cost money in non-production time and, in some cases, may lead to equipment damage and costly failures. The apparatus disclosed herein may focus on improving the maintenance and ongoing health of the system 100 including the glue application box 102. By maintaining a higher level of cleanliness on the glue application box 102, fewer system downtime events may be required, therefore potentially increasing productivity and throughput of the system 100. The apparatus may be utilized in all papermaking machines in a category that use a glue application box 102 as disclosed herein.

One advantage of the apparatus disclosed herein may be that the apparatus may be configured to use a minimum amount of resources required to keep the solution low cost, may be further configured to include devices to ensure equipment health and control unexpected movements of the new equipment, and may be further configured to identify the exact movement speed of the cleaning device 120 to achieve correct residence time of the cleaning method. A business goal of the apparatus may be to demonstrate fewer intervention needs for manual cleaning of the glue application box 102, which will require papermachine downtime, non-production time.

### Aspects

The disclosure herein may feature one or more aspects , such as but not limited to:
A. An apparatus to prevent buildup of glue on a glue application box of a system comprising a moving surface configured to move in a direction from a leading edge to a trailing edge of the glue application box and the system is configured to direct glue from within the glue application box onto the moving surface, said apparatus comprising: a cleaning device comprising a wiping mechanism configured to move along an outer surface of the trailing edge of the glue application box in a wiping direction (e.g., CD) to remove the buildup of glue on the outer surface of the trailing edge.
B. The apparatus of paragraph A, wherein a top of the trailing edge of the glue application box comprises an air seal defining a slot in flow communication with one or more air channels configured to direct an air stream toward the moving surface; and wherein the wiping mechanism is configured to be positioned within the slot and is configured to move within the slot in the wiping direction to remove the buildup of glue within the slot.
C. The apparatus of paragraphs A or B, wherein the wiping mechanism is at least partially oriented in the wiping direction.
D. The apparatus of any of paragraphs A through C, wherein the system is a papermaking system.
E. The apparatus of any of paragraphs A through D, wherein the moving surface is a yankee.
F. The apparatus of any of paragraphs A through E, wherein the apparatus is configured to direct one or more streams of fluid on the outer surface of the trailing edge in a direction that is substantially perpendicular to a direction of movement of the cleaning device along the outer surface of the trailing edge, wherein the one or more streams of fluid are configured to remove or moisten the buildup of glue on the outer surface of the trailing edge.
G. The apparatus of any of paragraphs A through F, wherein the fluid is water and wherein a temperature of the water is about 60 degrees F or in a range from about 50 degrees F to about 70 degrees F.
H. The apparatus of any of paragraphs A through G, wherein the cleaning device is configured to move along the outer surface of the trailing edge at a speed that is between about 0.9 inches per second and 1.0 inches per second.
I. The apparatus of any of paragraphs A through H, wherein the one or more streams of fluid are configured to be directed at a flowrate between about 1 gallons per minute to about 2 gallons per minute and at a pressure between about 10 pounds per square inch and 20 pounds per square inch.
J. The apparatus of any of paragraphs A through I, wherein a top of the trailing edge of the glue application box comprises an air seal and wherein the apparatus is configured to direct a first stream of the one or more streams in a direction that is substantially perpendicular to a first surface of the trailing edge that is adjacent to the top of the trailing edge and below the air seal.
K. The apparatus of any of paragraphs A through J, wherein the trailing edge of the glue application box comprises a second surface that includes a cladding portion of the trailing edge, wherein the second surface is angled relative to the first surface and wherein the apparatus is configured to direct a second stream of the one or more streams in a direction that is substantially perpendicular to the second surface of the trailing edge.
L. The apparatus of any of paragraphs A through K, wherein the apparatus is further configured to direct the one or more streams of fluid in the direction that is substantially perpendicular to a direction that the glue is directed onto the moving surface.
M. The apparatus of any of paragraphs A through L, wherein the cleaning device defines one or more openings and wherein the apparatus is configured to direct the one or more streams of fluid from the respective one or more openings defined by the cleaning device.
N. The apparatus of any of paragraphs A through M, wherein the fluid is water; wherein the system comprises a hard pipe that defines a water line configured to supply water from a water source; and wherein the apparatus includes a flexible line in flow communication with the hard line and in flow communication with the one or more openings of the barrier such that the apparatus is configured to direct the one or more streams of water from the one or more openings.
O. The apparatus of any of paragraphs A through N, wherein a top of the trailing edge of the glue application box comprises an air seal and wherein the cleaning device defines: a first portion defining a first opening of the one or more openings, wherein the apparatus is configured to direct a first stream of the one or more streams from the first opening in a direction that is substantially perpendicular to a first surface of the trailing edge that is adjacent the top of the trailing edge and below the air seal, wherein the first portion of the cleaning device is configured to move along the first surface of the trailing edge; and a second portion defining a second opening of the cleaning device, wherein the apparatus is configured to direct a second stream of the one or more streams from the second opening in a direction that is substantially perpendicular to a second surface including a cladding of the trailing edge that is below the first surface and is angled relative to the first surface, wherein the second portion of the cleaning device is configured to move along the second surface of the trailing edge.
P. The apparatus of any of paragraphs A through O, wherein the first portion defines the first opening such that an axis of the first opening is aligned in a first direction; wherein the second portion defines the second opening such that an axis of the second opening is aligned in a second direction; and wherein an angle between the first direction and the second direction is greater than 0 degrees and less than 90 degrees.
Q. The apparatus of any of paragraphs A through P, wherein the cleaning device further defines an inlet and one or more interior channels between the inlet and the first and second openings such that the inlet is in flow communication with the first and second openings; and wherein an inner diameter of the inlet or the one or more interior channels is greater than an inner diameter of the first and second openings.
R. The apparatus of any of paragraphs A through Q, further comprising: a motor or actuator configured to engage a bottom of the cleaning device that is opposite from a top of the cleaning device comprising the wiping mechanism; and wherein the motor or actuator is configured to engage the bottom of the cleaning device to move the cleaning device in a direction along the outer surface of the trailing edge that is parallel to the wiping direction.
S. The apparatus of any of paragraphs A through R, wherein the cleaning device further comprises a hook portion configured to engage the top of the trailing edge.
T. The apparatus of any of paragraphs A through S, wherein the system comprises a hard pipe that defines a water line configured to supply water from a water source; wherein the apparatus includes a flexible line in flow communication with the hard line and in flow communication with nozzles positioned within the one or more openings of the cleaning device such that the apparatus is configured to direct the one or more streams of water from the nozzles within the one or more openings; and wherein the cleaning device defines an inlet opening in flow communication with the flexible line and further defines one or more interior channels between the inlet and the one or more openings such that water from the flexible line is configured to flow through the inlet and the one or more interior channels to the nozzles positioned within the one or more openings.
U. An apparatus to prevent buildup of glue on a glue application box of a papermaking system comprising a yankee configured to move in a direction from a leading edge to a trailing edge of the glue application box, wherein the system is configured to direct glue from within the glue application box onto the yankee, and wherein a top of the trailing edge of the glue application box comprises an air seal defining a slot in flow communication with one or more air channels configured to direct an air stream toward the moving surface; wherein said apparatus comprising: a cleaning device comprising a wiping mechanism configured to be positioned within the slot and configured to move within the slot in a wiping direction to remove the buildup of glue within the slot.
V. The apparatus of paragraph U, wherein the cleaning device further comprises: a first portion defining a first opening configured to direct a first stream of water in a direction that is substantially perpendicular to a direction of movement of the cleaning device along the outer surface and is further substantially perpendicular to a first surface of the trailing edge that is adjacent to the top of the trailing edge and below the air seal, and a second portion defining a second opening configured to direct a second stream of water in a direction that is substantially perpendicular to the direction of movement of the cleaning device along the outer surface and is further substantially perpendicular to a second surface of the trailing edge that includes a cladding of the trailing edge, wherein the second surface is below the first surface and is angled relative to the first surface, wherein the apparatus is configured to direct the first stream of water and the second stream of water from the respective first and second openings onto the respective first and second surfaces to remove or moisten the buildup of glue on the outer surface of the trailing edge.
W. The apparatus of any of paragraphs U through V, wherein the cleaning device is configured to move along the outer surface of the trailing edge at a speed that is between about 0.9 inches per second and 1.0 inches per second.
X. The apparatus of any of paragraphs U through W, wherein the first and second streams of water are configured to be directed at a flowrate between about 1 gallons per minute to about 2 gallons per minute and at a pressure between about 10 pounds per square inch and 20 pounds per square inch.
Y. The apparatus of any of paragraphs U through X, wherein the cleaning device further defines: an inlet; and one or more interior channels in flow communication with the inlet and the first and second openings; wherein the inlet is configured to receive water from a water source of the system such that the water is directed into the inlet, through the interior channels and is directed from the first and second openings as the first and second streams.
Z. The apparatus of any of paragraphs U through Y, wherein the system comprises a hard pipe that defines a water line configured to supply water from the water source; and wherein the apparatus includes a flexible line in flow communication with the hard line and in flow communication with the inlet such that the cleaning device is configured to communicate water supplied at the inlet through the interior channels and directed out the first and second openings as the first and second streams.

AA. The apparatus of any of paragraphs U through Z,

wherein the first portion defines the first opening such that an axis of the first opening is aligned in a first direction;

wherein the second portion defines the second opening such that an axis of the second opening is aligned in a second direction; and

wherein an angle between the first direction and the second direction is greater than 0 degrees and less than 90 degrees.

AB. The apparatus of any of paragraphs U through AA, wherein an inner diameter of the inlet or the one or more interior channels is greater than an inner diameter of the first and second openings.

AC. The apparatus of any of paragraphs U through AB, wherein the inner diameters of the inlet, the one or more interior channels, the first opening and the second opening are selected such that the first and second streams of water are configured to be directed at a flowrate between about 1 gallons per minute to about 2 gallons per minute and at a pressure between about 10 pounds per square inch and 20 pounds per square inch.

AD. The apparatus of any of paragraphs U through AC, wherein the cleaning device further comprises a hook portion configured to engage the top of the trailing edge, wherein the first portion of the cleaning device is positioned between the hook portion and the second portion.

### LINEAR DISTANCES

Linear distances may be measured by any appropriate instrument that is calibrated and capable of a measurement to the nearest 0.1 mm. Linear distances modified by the term “about” mean that the specified value may be +/- 0.1mm. Area measurements are made using the projected area of the article, as viewed orthogonally to the plane of the longitudinal and transverse axes, in square millimeters to the nearest 0.1 mm². Area measurements modified by the term “about” mean that the specified value may be +/- 0.1mm².

### Further Definitions and Cross-References

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An apparatus to prevent buildup of glue on a glue application box of a system comprising a moving surface configured to move in a direction from a leading edge to a trailing edge of the glue application box and the system is configured to direct glue from within the glue application box onto the moving surface, said apparatus comprising:
a cleaning device comprising a wiping mechanism configured to move along an outer surface of the trailing edge of the glue application box in a wiping direction to remove the buildup of glue on the outer surface of the trailing edge.

2. The apparatus of claim 1, wherein a top of the trailing edge of the glue application box comprises an air seal defining a slot in flow communication with one or more air channels configured to direct an air stream toward the moving surface; and
wherein the wiping mechanism is configured to be positioned within the slot and is configured to move within the slot in the wiping direction to remove the buildup of glue within the slot.

3. The apparatus of claim 1, wherein the wiping mechanism is at least partially oriented in the wiping direction.

4. The apparatus of claim 1, wherein the system is a papermaking system.

5. The apparatus of claim 4, wherein the moving surface is a yankee.

6. The apparatus of claim 1, wherein the apparatus is configured to direct one or more streams of fluid on the outer surface of the trailing edge in a direction that is substantially perpendicular to a direction of movement of the cleaning device along the outer surface of the trailing edge, wherein the one or more streams of fluid are configured to remove or moisten the buildup of glue on the outer surface of the trailing edge.

7. The apparatus of claim 6, wherein the fluid is water.

8. The apparatus of claim 6, wherein the cleaning device is configured to move along the outer surface of the trailing edge at a speed that is between about 0.9 inches per second and 1.0 inches per second.

9. The apparatus of claim 6, wherein the one or more streams of fluid are configured to be directed at a flowrate between about 1 gallons per minute to about 2 gallons per minute and at a pressure between about 10 pounds per square inch and 20 pounds per square inch.

10. The apparatus of claim 6, wherein a top of the trailing edge of the glue application box comprises an air seal and wherein the apparatus is configured to direct a first stream of the one or more streams in a direction that is substantially perpendicular to a first surface of the trailing edge that is adjacent to the top of the trailing edge and below the air seal.

11. The apparatus of claim 10, wherein the trailing edge of the glue application box comprises a second surface that includes a cladding portion of the trailing edge, wherein the second surface is angled relative to the first surface and wherein the apparatus is configured to direct a second stream of the one or more streams in a direction that is substantially perpendicular to the second surface of the trailing edge.

12. The apparatus of claim 6, wherein the apparatus is further configured to direct the one or more streams of fluid in the direction that is substantially perpendicular to a direction that the glue is directed onto the moving surface.

13. The apparatus of claim 6, wherein the cleaning device defines one or more openings and wherein the apparatus is configured to direct the one or more streams of fluid from the respective one or more openings defined by the cleaning device.

14. The apparatus of claim 13,
wherein the fluid is water;
wherein the system comprises a hard pipe that defines a water line configured to supply water from a water source; and
wherein the apparatus includes a flexible line in flow communication with the hard line and in flow communication with the one or more openings of the barrier such that the apparatus is configured to direct the one or more streams of water from the one or more openings.

15. The apparatus of claim 6, wherein a top of the trailing edge of the glue application box comprises an air seal and wherein the cleaning device defines:
a first portion defining a first opening of the one or more openings, wherein the apparatus is configured to direct a first stream of the one or more streams from the first opening in a direction that is substantially perpendicular to a first surface of the trailing edge that is adjacent the top of the trailing edge and below the air seal, wherein the first portion of the cleaning device is configured to move along the first surface of the trailing edge; and
a second portion defining a second opening of the cleaning device, wherein the apparatus is configured to direct a second stream of the one or more streams from the second opening in a direction that is substantially perpendicular to a second surface including a cladding of the trailing edge that is below the first surface and is angled relative to the first surface, wherein the second portion of the cleaning device is configured to move along the second surface of the trailing edge.

16. The apparatus of claim 15,
wherein the first portion defines the first opening such that an axis of the first opening is aligned in a first direction;
wherein the second portion defines the second opening such that an axis of the second opening is aligned in a second direction; and
wherein an angle between the first direction and the second direction is greater than 0 degrees and less than 90 degrees.

17. The apparatus of claim 15, wherein the cleaning device further defines an inlet and one or more interior channels between the inlet and the first and second openings such that the inlet is in flow communication with the first and second openings; and
wherein an inner diameter of the inlet or the one or more interior channels is greater than an inner diameter of the first and second openings.

18. The apparatus of claim 1, further comprising:
a motor or actuator configured to engage a bottom of the cleaning device that is opposite from a top of the cleaning device comprising the wiping mechanism; and
wherein the motor or actuator is configured to engage the bottom of the cleaning device to move the cleaning device in a direction along the outer surface of the trailing edge that is parallel to the wiping direction.

19. The apparatus of claim 2, wherein the cleaning device further comprises a hook portion configured to engage the top of the trailing edge.

20. The apparatus of claim 15,
wherein the system comprises a hard pipe that defines a water line configured to supply water from a water source;
wherein the apparatus includes a flexible line in flow communication with the hard line and in flow communication with nozzles positioned within the one or more openings of the cleaning device such that the apparatus is configured to direct the one or more streams of water from the nozzles within the one or more openings; and
wherein the cleaning device defines an inlet opening in flow communication with the flexible line and further defines one or more interior channels between the inlet and the one or more openings such that water from the flexible line is configured to flow through the inlet and the one or more interior channels to the nozzles positioned within the one or more openings.

21. An apparatus to prevent buildup of glue on a glue application box of a papermaking system comprising a yankee configured to move in a direction from a leading edge to a trailing edge of the glue application box, wherein the system is configured to direct glue from within the glue application box onto the yankee, and wherein a top of the trailing edge of the glue application box comprises an air seal defining a slot in flow communication with one or more air channels configured to direct an air stream toward the moving surface; wherein said apparatus comprising:
a cleaning device comprising a wiping mechanism configured to be positioned within the slot and configured to move within the slot in a wiping direction to remove the buildup of glue within the slot.

22. The apparatus of claim 21, wherein the cleaning device further comprises:
a first portion defining a first opening configured to direct a first stream of water in a direction that is substantially perpendicular to a direction of movement of the cleaning device along the outer surface and is further substantially perpendicular to a first surface of the trailing edge that is adjacent to the top of the trailing edge and below the air seal, and
a second portion defining a second opening configured to direct a second stream of water in a direction that is substantially perpendicular to the direction of movement of the cleaning device along the outer surface and is further substantially perpendicular to a second surface of the trailing edge that includes a cladding of the trailing edge, wherein the second surface is below the first surface and is angled relative to the first surface,
wherein the apparatus is configured to direct the first stream of water and the second stream of water from the respective first and second openings onto the respective first and second surfaces to remove or moisten the buildup of glue on the outer surface of the trailing edge.

23. The apparatus of claim 22, wherein the cleaning device is configured to move along the outer surface of the trailing edge at a speed that is between about 0.9 inches per second and 1.0 inches per second.

24. The apparatus of claim 22, wherein the first and second streams of water are configured to be directed at a flowrate between about 1 gallons per minute to about 2 gallons per minute and at a pressure between about 10 pounds per square inch and 20 pounds per square inch.

25. The apparatus of claim 22, wherein the cleaning device further defines:
an inlet; and
one or more interior channels in flow communication with the inlet and the first and second openings;
wherein the inlet is configured to receive water from a water source of the system such that the water is directed into the inlet, through the interior channels and is directed from the first and second openings as the first and second streams.

26. The apparatus of claim 25,
wherein the system comprises a hard pipe that defines a water line configured to supply water from the water source; and
wherein the apparatus includes a flexible line in flow communication with the hard line and in flow communication with the inlet such that the cleaning device is configured to communicate water supplied at the inlet through the interior channels and directed out the first and second openings as the first and second streams.

27. The apparatus of claim 22,
wherein the first portion defines the first opening such that an axis of the first opening is aligned in a first direction;
wherein the second portion defines the second opening such that an axis of the second opening is aligned in a second direction; and
wherein an angle between the first direction and the second direction is greater than 0 degrees and less than 90 degrees.

28. The apparatus of claim 25, wherein an inner diameter of the inlet or the one or more interior channels is greater than an inner diameter of the first and second openings.

29. The apparatus of claim 28, wherein the inner diameters of the inlet, the one or more interior channels, the first opening and the second opening are selected such that the first and second streams of water are configured to be directed at a flowrate between about 1 gallons per minute to about 2 gallons per minute and at a pressure between about 10 pounds per square inch and 20 pounds per square inch.

30. The apparatus of claim 22, wherein the cleaning device further comprises a hook portion configured to engage the top of the trailing edge, wherein the first portion of the cleaning device is positioned between the hook portion and the second portion.
